(19) United States
(12) Patent Application Publication
(10) Pub. No.: US 2009/0273436 A1
(43) Pub. Date: Nov. 5, 2009

(54) METHOD AND DEVICE FOR CONTROLLING USE OF POWER TOOLS

(76) Inventors: Alan GLUCK, Lincolnwood, IL (US); Brett PAULS, Lincolnwood, IL (US)

Correspondence Address: OSTROLENK FABER GERB & SOFFEN, 1180 AVENUE OF THE AMERICAS, NEW YORK, NY, 100368403, US

(21) Appl. No.: 12/114,925

(22) Filed: May 5, 2008

(51) Int. Cl. G05B 19/00

(52) U.S. Cl. 340/5.2

(57) ABSTRACT

A method and device for blocking unauthorized use of power tools with a circuit-interrupting device being positioned between a power tool and an electrical power source (AC power or battery power). The circuit-interrupting device is in a normally open circuit configuration to prevent unauthorized use. Authorized use is with a transmitted signal from a remote signal transmitting device (such as RF, bluetooth and infra-red generating fob or PDA) to a signal receiving device, operatively linked to the circuit-interrupting device, to close the circuit upon receipt of a signal and to open the circuit (and deactivation of the power tool) with removal of the signal.

### FIELD OF THE INVENTION

This invention relates to power tools and specifically to blocking of unauthorized use of power tools utilizing electrical power sources.

### BACKGROUND OF THE INVENTION

Power tools such as stationary heavy duty tools including table saws, lathes, drill presses and the like, as well as lighter duty tools such as portable hand tools including drills, routers, circular saws, etc., may be damaged, effect damage and/or be hazardous if used improperly. Users of such tools are therefore trained in their use, with proper use and safety guidelines. Unauthorized use of these tools is thus problematic for many reasons including from safety standpoints, since unauthorized users are often only familiar with rudiments of operation but not of requisite safety procedures. In addition, improper use of tools by unauthorized users may result in damage to the tools, such as damage to cutting parts or motor elements (either from lack of knowledge or carelessness) and to objects being subject to the use of the tools.

Expedients normally used to prevent unauthorized use have generally been confined to placing locks on the tools or by restricting access to the work areas where the tools are located and used. Such expedients are however, readily circumvented or may actually provide a practical impediment to use by authorized users.

### SUMMARY OF THE INVENTION

It is accordingly an object of the present invention to provide a method and a device for effecting such method, for the blocking or prevention of unauthorized use of electrically powered tools, but with a simple wireless signal activation control, either by a single control or by fully passive means, for permitting authorized users to readily use the tools.

It is a further object of the present invention to provide such blocking or prevention of unauthorized use by preventing completion of an electrical circuit in the electrical circuit used to power the tools. Unblocking, with authorized use capability, is in conjunction with a separate adjuvant device, remote from the tools and the electrical circuit, capable of locally wirelessly transmitting a unique activation signal for effecting completion of the electrical circuit and activated operative use of the power tool.

It is a still further object of the present invention to either effect electrical circuit interruption within the circuitry of the power tools or within the power source, such as a power strip to which the power tools are electrically connected. The power tool or power strip, containing the electrical circuit interruption, are provided with an activation signal receiver with operational elements integrated therewith, for wirelessly receiving and processing a unique activation signal for completing the interrupted electrical circuit to permit tool operation.

It is yet another object of the present invention to provide such tools in the “deactivated” non-powerable state until and unless signal-activated, with signal activation constituting authorized use.

These and other objects, features and advantages of the present invention will become more evident from the following discussion and drawings in which:

### SHORT DESCRIPTION OF THE DRAWINGS

FIG. 1 is a perspective view of a typical table saw plugged into a power strip having the circuit-interrupting device of the present invention, with the strip being connected to an AC power outlet electrical source;

FIG. 2 is an expanded cutaway view of the power strip of FIG. 1, showing circuit-interrupting and activation components, signal receiver and a remote wireless-activating signal transmitting fob;

FIG. 2a is an alternative activating signal source of a personal digital assistant (PDA), with capability of optional enhanced security in preventing unauthorized used in the form of alphanumeric input/output, wirelessly linked to the activation signal receiver of the circuit-interrupting device;

FIG. 3 is a block diagram of the components of the circuit-interrupting device of the present invention with the operational process as applied to the embodiment of the invention shown in FIG. 1; and

FIG. 4 depicts another embodiment of the present invention of a portable battery powered drill with partially sectioned handle showing circuit-interrupting elements of the present invention integrated therewith.

### DETAILED DESCRIPTION OF THE DRAWINGS

The present invention comprises a method and device for blocking or prevention of initial activation of a power tool by non-authorized users as, among other things, a prophylactic measure to prevent unauthorized and often untrained people from using power tools.

Generally the present invention comprises a method for preventing the unauthorized use of electrically powered tools while readily allowing authorized use.

The present invention comprises, in a power tool operating system wherein the power tool is electrically connected to an electrical power source (either AC outlet current or integrated DC battery power with the battery contained in a housing adapted to be latched to the tool) for the operational powering thereof, a method for preventing the unauthorized use of electrically powered tools while readily allowing authorized use, the method comprises the steps of:
a) providing a circuit-interrupting device between the tool and an electrical power source for powering the tool, with the circuit-interrupting device being configured to be in a normally interrupted condition with an open relay in the power circuit unless wirelessly signaled with a unique signal to close the relay and/or while the tool is in an active powered state;
b) connecting an activation signal receiving device to the circuit-interrupting device wherein a signal from a remote activation signal transmitting device is wirelessly received by the activation signal receiving device and relayed to the circuit-interrupting device to close the relay and complete a power circuit to the tool, thereby permitting the tool to be power activated;
c) configuring an activation signal transmitting device remote from the activation signal receiving device to transmit a wireless signal while in proximity to the receiving device which signal is received by the receiving device and which signal is transmitted to the circuit interrupting device to cause the circuit interrupting device to close the relay and provide operating power to the tool; and
d) deactivating the power tool by one of:
   i) preventing an activation signal from reaching the signal receiving device to thereby cause the circuit-interrupting device to resume its normally circuit interrupting condition by opening the relay;
   ii) providing a deactivation signal to the signal receiving device to cause the circuit-interrupting device to resume its normally circuit interrupting condition by opening the relay; and
   iii) preventing operating current from reaching the tool whereby the circuit interrupting device is configured to detect such prevention and resume its normally circuit interrupting condition by opening the relay.

It is preferred that the method further includes prevention of powering-redeployment of the tool to a power source without a circuit-interrupting device, to prevent unauthorized users from bypassing the use impediments of the present invention. An example of such prevention of powering-redeployment is locking the power cord of a tool to the power strip containing the circuit-interrupting device. However, blocking of powering redeployment is an additional preferred, though not necessary step. It is particularly preferred when the possibility of such redeployment is likely such as with other nearby outlets or where the power tool can be directly connected to an outlet without the power strip containing a circuit interrupting device.

The activation signal is a unique one which is specifically paired between the signal transmitter and receiver and does not encompass common sound signals such as hand claps, as may be readily available to non-authorized users. Examples of activation signals include wireless transmissions of RF signals, infra red signals and paired bluetooth communications.

The present invention further comprises a device for preventing or blocking the unauthorized use of electrically powered tools. The device comprises a circuit-interrupting device configured for deployment between the operating power circuit of a power tool and an electrical power source, with the circuit-interrupting device being in the normal open circuit condition. The device for preventing or blocking the unauthorized use of power tools comprises:
a) a circuit-interrupting device comprising:
   i) an open relay configured to be incorporated into a circuit which supplies power to a power tool; and
   ii) a microprocessor programmed to control the opening and closing of a relay in the power supply circuit of a power tool, and to maintain an opened position for the relay in the absence of an activating signal;
b) iii) an activation signal receiving device operationally connected to the microprocessor and configured to wirelessly receive activating signals from a remote activating signal transmitting device and to transmit the signal to the microprocessor to thereby effect closing of the relay; and
c) an activating signal transmitting device remote from the signal receiving device and operationally paired therewith which signal transmitting device transmits the activating signal to the signal receiving device wherein reception proximity therewith.

Depending on the electrical parameters in which the circuit interrupting devices are to be used, the circuit interrupting devices may further include transformers, rectifiers, conditioner elements and the like, to permit independent powering of the microprocessors and signal receiving elements by power sources which provide power to the tool.

The device for preventing unauthorized use of a power tool thus comprises an activation signal transmitter and an activation signal receiver device operatively wirelessly linked to each other. The activation signal receiver device is in turn directly operatively linked to the circuit-interrupting device whereby an activation signal transmitted from the activation signal transmitter device, in a location proximate to the activation signal receiver device, is received by the receiver to activate the circuit-interrupting device operatively linked thereto. The circuit between the power supply and the power tool is then closed with the power tool being activated or being set to be activatable.

A proximate location, as used herein, is a function of the type of signal being transmitted and the power of the transmitter. Thus, a bluetooth signal is generally effective over a standard maximum distance of about 30 feet. Infra red signals require line of sight and depend on signal strength and typically range from 30 to 50 feet. RF transmissions from battery powered devices such as battery powered fobs can range to 100 feet with the operation reception range being dependent on attenuation by intervening objects and walls. It is preferred that the activation signal operation reception range be proximate, i.e. a maximum of 100 feet or within a specific working area, to avoid inadvertent activation from an operationally remote location.

In a preferred embodiment, particularly for stationary power tools, the circuit-interrupting device is integrated with a power strip used between an AC power outlet source, such as a standard 120 VAC and the power tool. In order to prevent redeployment of the tool to another power source without the circuit-interrupting device, the power cord of the tool is preferably anchored to the power strip with a non-readily removable connection. Other expedients may be similarly used to the same effect.

The circuit-interrupting device may also be integrated with the tool itself and this is especially preferred with respect to portable tools which may be easily moved to other non-controlled power sources or which are battery powered. The circuit-interrupting device may be positioned at any location within the tool circuit and, with a battery powered tool, is preferably located in a circuit between the battery and the operational circuitry of the tool.

The device itself preferably comprises a transformer conditioner with a 120 VAC input (with a battery powered tool, the conditioner for converting from AC to DC is not necessary) and a 5VDC output (typical of current requirements for driving microprocessors and is not limiting) to drive a microprocessor, programmed to close a normally open relay, with a transmitted signal from, for example, a dedicated fob with RF signal, (with infra-red or bluetooth transmission), or a configured dedicated bluetooth controller device. The device further includes a relay which is integrated with the power supply circuit, with the relay being in the normally open position unless signaled to be closed to provide power to the tool.

The controlling microprocessor may be programmed so that the relay of the circuit interrupting device remains closed during powered operation of the tool. When power is turned off from the tool, e.g. by pressing the tool power-off switch, the circuit interrupting device is configured to reset itself with an open relay condition, and the tool remains non-operable without another signal. Authorized use of the device thereafter requires turning on the tool and the transmission of a new activation signal.

Alternatively, and particularly with respect to bluetooth signal operation, an activation signal to keep the relay closed is constantly being sent, with linking of the signal transmitting device and the circuit interrupting device. As a result, and with turn off or removal of the signal device from proximity with the tool, the power circuit is opened and tool operation is automatically turned off for lack of powering current. Operational variations are possible and are within the scope of the present invention. For example, a single signaling device can be used to activate a series of tools connected to a single power strip or alternatively individual signal transmitting devices may be linked for powering of different tools.

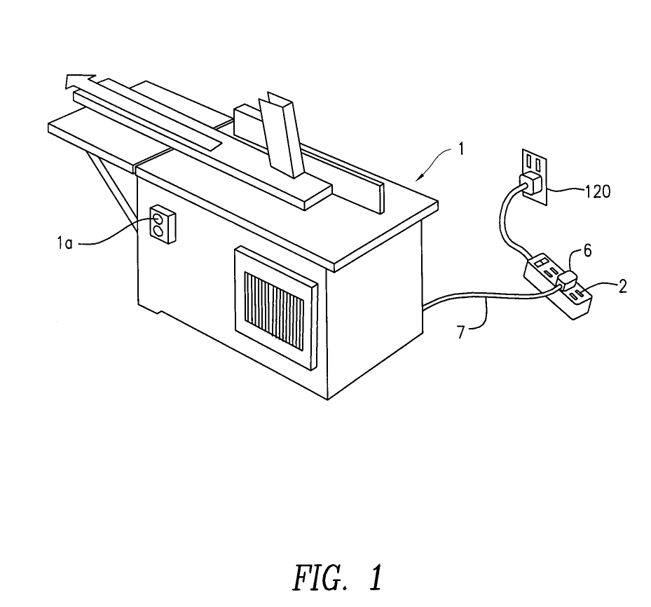

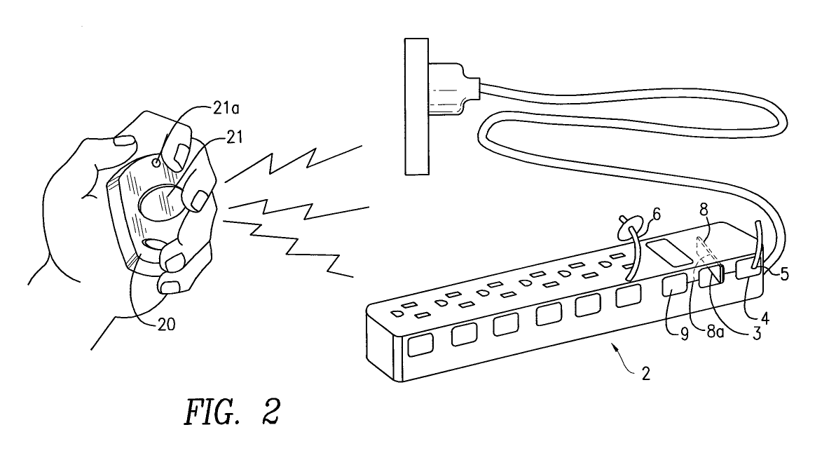

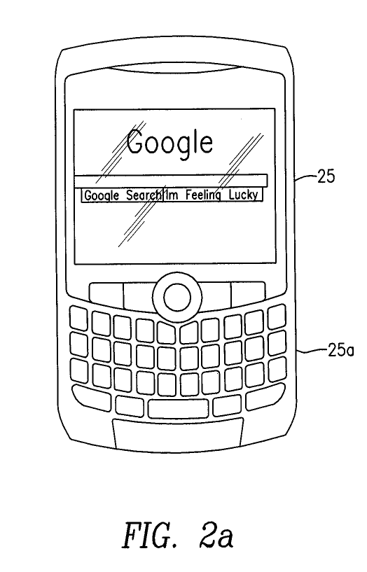

With specific reference to the drawings, in FIG. 1, a stationary power tool in the form of a table saw 1 is plugged into a power strip 2 (shown in greater detail in FIG. 2) having a circuit interrupter device 3 with activation signal receiver 4 and signal receiving antenna 5. The power strip 2 is provided with a non-readily removable plug tie-down lock 6 to prevent power plug 7 of table saw 1 from being removed and being plugged directly into a wall outlet. The power strip 2 is shown as being plugged into a wall outlet 120, which is typically, in the US, a 120VAC source. Configuration for other current parameters such 220VAC with separately configured sockets are all within the scope of the present invention.

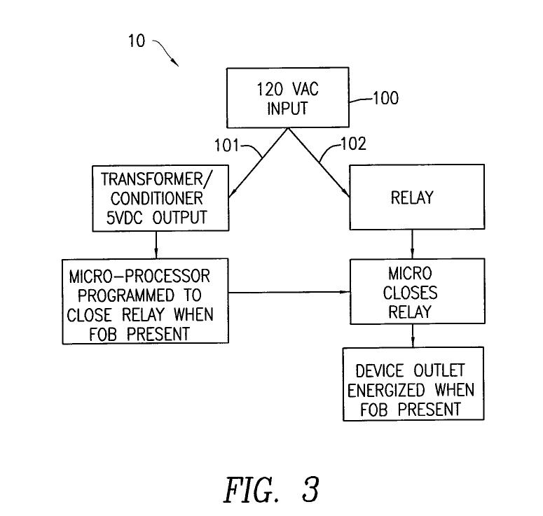

The power strip 2 comprises a transformer/conditioner 9, which, as shown in chart 10 of FIG. 3, converts the 120VAC to a 5VDC (typical but not limiting) output. The output DC current powers a microprocessor 8, which has been programmed to close a relay 8a. Closing of the relay, in the presence of an activating signal, completes the power circuit to provide power to devices plugged into sockets 2a in the power strip, such as table saw 1. The microprocessor 8 is connected to signal receiver 4, which receives activation signals from signal transmitter element 20.

Transmitter element 20 may be an RF fob with a toggle activation button 21 as shown in FIG. 1 or alternatively a PDA 25, as shown in FIG. 2A, with transmission options of RF, IR, bluetooth and the like (as available), with the further option of controlling activation signal transmission with an entry code via keyboard 25a. Optional button 21a, shown in FIG. 2, may be configured to provide a signal to open the relay.

In a preferred embodiment, activation signals are continuously or continually, at timed intervals, transmitted from the transmitter element 20 to the signal receiver 4 such that removal of the transmitter element 20 from proximity with the signal receiver 4 (and the power strip 2) causes the microprocessor 8 to close the relay and shut off power to the table saw 1. Such continuous signals are typical of bluetooth transmissions.

In another embodiment, in order to conserve battery power of the transmitter element 20, the microprocessor 8 is configured to close the relay with a single activation signal from transmitter element 20 and to be reset to the open relay position with a single deactivation signal from the transmitter elements 20 provided with activation signal button 21 and deactivation signal button 21a.

In a further embodiment, adapted to prevent unwanted work-shut-down resulting from a defective transmitter element 20, or when the battery of the transmitter element is drained, the microprocessor 8 is configured to be activated by a single signal and to continuously maintain a closed relay on the tool powering circuit as long as there is current in the tool powering circuit. Interruption of the current in the tool powering circuit, such as by turning the power tool off with manual switch 1a, is monitored by the microprocessor 8 to reset the closed relay to the original open circuit condition. The tool is then unable to be turned on unless and until the signal receiver 4 receives a new activation signal from transmitter element 20 to microprocessor 8 to close the relay.

With reference to FIG. 3, the operation of the unauthorized user prevent device is shown in block chart 10. The 120VAC input 100 is split to a first circuit 101 which continuously powers the circuit-interrupting device. A second circuit 102, which provides current to power the tool, is normally open, without current, and includes a normally opened relay controlled by the circuit-interrupting device. As shown in FIG. 3, the presence of an activation fob with a transmitted activation signal causes the programmed micro-processor to effect closure of the relay and flow of current to the tool. Removal of the fob resets the relay to the open condition. As a result, an unauthorized user, without an activating fob, is unable to use the tool and an authorized user carrying a fob is able to readily use the tool.

Powering of the circuit interrupting device is with input of the 120VAC power source through a transformer/conditioner 7, with, for example, a 5VDC output as shown to power a micro-processor 8 for controlling opening and closing of relay. The powered micro-processor is activated to close and maintain the relay in the closed position with signals from the fob. Removal of the fob from proximity to the micro-processor serves to cause the micro-processor to open the relay and shut off power to the tool.

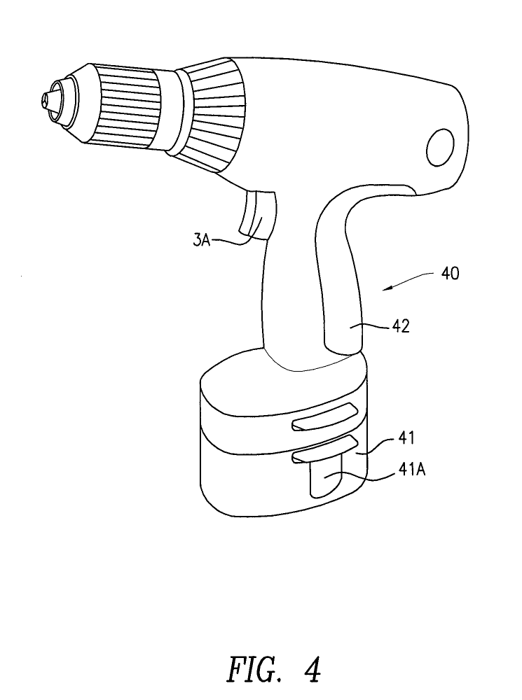

While inclusion of the circuit-interrupting device 3 within a power strip is convenient such as for use with other tools powered by the same power strip, the circuit interrupting device 3a may be directly integrated within the tool such as shown in FIG. 4. This has particular applicability to more portable tools, which, because of their portability, may not be readily used with a specific power strip. In addition, battery powered tools, which have proliferated, do not utilize power strips.

Thus, in a further embodiment of the present invention with particular applicability to portable and battery powered tools such as the hand drill 40 shown in FIG. 4, the circuit interrupting device 3a is integrated within the drill 40 itself or within the battery power supply casing 41. Portable tools invariably have handles such as handle 42 through which the power circuit for the tool is often located especially with batteries which clamp onto the handles as illustrated with drill 40. Accordingly, the handles can be readily adapted, even with existing tools to incorporate the circuit interrupting device of the present invention without conditioners. The circuit interrupting device is either powered by the battery which powers the device and which is often rechargeable or alternatively, the circuit interrupting device may be integrated with the battery 41 itself within battery housing 41a.

It is understood that the above examples and discussion are merely exemplary of the invention and that changes may be made such as in function, structure and relation between elements without departing from the scope of the present invention as defined in the following claims.

What is claimed is:

1. A method for blocking the unauthorized use of electrically powered tools while allowing authorized use, the method comprising the steps of:
a) providing a circuit-interrupting device in an electrical power circuit between the tool and an electrical power source for powering the tool, with the circuit-interrupting device being configured to be in a normally circuit interrupted condition with an open relay in the electrical power circuit between the tool and the electrical power source;
b) connecting an activation signal receiving device to the circuit-interrupting device such that an activation signal from a remote activation signal transmitting device is wirelessly received by the activation signal receiving device and relayed to the circuit-interrupting device which is configured to close the relay, upon receiving the signal, to complete an electrical power circuit to the tool, thereby permitting the tool to be power activated;
c) configuring an activation signal transmitting device, remote from the activation signal receiving device, to transmit a wireless signal, while in proximity with the receiving device, which signal is received by the receiving device and transmitted to the circuit interrupting device to cause the circuit interrupting device to close the relay and provide operating power to the tool; and
d) configuring at least one of the circuit-interrupting device and activation signal transmitting device to deactivate the power tool after use thereof by one of:
i) preventing an activation signal from reaching the signal receiving device to thereby cause the circuit-interrupting device to resume its normally circuit interrupting condition by opening the relay;
ii) providing a deactivation signal to the signal receiving device to cause the circuit-interrupting device to resume its normally circuit interrupting condition by opening the relay; and
iii) preventing operating current from reaching the tool with the circuit interrupting device being configured to detect such prevention and resume its normally circuit interrupting condition by opening the relay.

2. The method of claim 1, wherein the circuit interrupting device and the activation signal receiving device are integrated with a power strip element configured to be plugged into an alternating current (AC) electrical power source as part of the electric power circuit.

3. The method of claim 1, wherein the circuit interrupting device and the activation signal receiving device are integrated with the power tool as part of the electric power circuit.

4. The method of claim 3, wherein the power tool is portable and the electrical power source is a battery.

5. The method of claim 4, wherein the battery is contained within a housing configured to be latched to the power tool and wherein the circuit interrupting device and the activation signal receiving device are operatively disposed within the housing.

6. The method of claim 1 wherein the activation and deactivation signals are one of radio frequency (RF), bluetooth, and infra red transmissions.

7. The method of claim 6, wherein the effective range of the activation and deactivation signals is up to 100 feet.

8. The method of claim 6, wherein the activation signal is a continuous bluetooth transmission, with removal of the activation signal from reception by the activation signal receiver causing the circuit interrupting device to open the relay and deactivate the power tool.

9. The method of claim 6 wherein the activation signal transmitter is one of a hand held fob with an activation button and a personal digital assistant (PDA) configured for entry code activation signal generation.

10. A device for preventing the unauthorized use of electrically powered tools while allowing authorized use thereof, the device comprising:
a) a circuit-interrupting device comprising:
i) a relay configured to be incorporated into an electrical circuit which supplies electrical power to a power tool;
ii) a control circuit programmed to control the opening and closing of the relay, and to maintain the relay in an open position in the absence of an activating signal;
b) an activation signal receiving device operationally connected to the control circuit and configured to wirelessly receive activating signals from a remote activating signal transmitting device and to transmit the signal to the microprocessor to thereby effect closing of the relay;
c) an activating signal transmitting device remote from the signal receiving device and operationally paired therewith, which signal transmitting device is configured to transmit the activating signal to the signal receiving device when in reception proximity therewith.

11. The device for preventing unauthorized use of claim 10, wherein the circuit interrupting device and the activation signal receiving device are integrated with a power strip element configured to be plugged into an alternating current (AC) electrical power source as part of the electric power circuit.

12. The device for blocking unauthorized use of claim 10, the power strip element comprises a locking element to block electrical removal of the power tool from the power strip element.

13. The device for preventing unauthorized use of claim 10 in combination with a power tool and wherein the circuit interrupting device and the activation signal receiving device are integrated with the power tool.

14. The device for preventing unauthorized use of claim 12, wherein the power tool is portable and the electrical power source is a battery with a direct current (DC) electrical power source.

15. The device for preventing unauthorized use of claim 13, wherein the wherein the battery is contained within a housing configured to be latched to the power tool and wherein the circuit interrupting device and the activation signal receiving device are operatively disposed within the housing.

16. The device for preventing unauthorized use claim 10, wherein the activation and deactivation signals are one of radio frequency (RF), bluetooth, and infra-red transmissions.

17. The device for preventing unauthorized use claim 15, wherein the effective range of the activation and deactivation signals is up to 100 feet.

18. The device for preventing unauthorized use of claim 16, wherein the activation signal is a continuous bluetooth transmission, with removal of the activation signal from reception by the activation signal receiver causing the circuit interrupting device to open the relay and deactivate the power tool.

19. The device for preventing unauthorized use of claim 16, wherein the activation signal transmitter is one of a hand held fob and a PDA.

20. The device for preventing unauthorized use of claim 19, wherein the PDA is configured to transmit activation signals with the entry of an entry code.
